(19) United States
(12) Patent Application Publication
(10) Pub. No.: US 2003/0145954 A1
(43) Pub. Date: Aug. 7, 2003

(54) Wallpapering aid

(76) Inventor: Henry Kelvin James, Middlesex (GB)

Correspondence Address: IPSOLON LLP, 805 SW BROADWAY, #2740, PORTLAND, OR, 97205, US

(21) Appl. No.: 10/220,583

(22) PCT Filed: Feb. 26, 2001
(86) PCT No.: PCT/GB01/00821

(30) Foreign Application Priority Data
Feb. 29, 2000 (GB) 0004873.6

(51) Int. Cl. B32B 31/00

(52) U.S. Cl. 156/577; 156/579

(57) ABSTRACT

A device for hanging wallpaper comprises a cradle in the form of a framework defining a receptacle for supporting a length of wallpaper folded in a concertina fashion. An applicator roller is mounted on the cradle for receiving therearound a leading edge portion of the supported length of wallpaper which is led out of the receptacle to the application roller through a throat of the cradle. A handle attached to the cradle enables a user to hold the device in a position of use with the applicator roller against a surface to be wallpapered and to move the device along the surface, so that the length of wallpaper is progressively unfolded from the cradle and pressed against the surface by the applicator roller as the device is moved along the surface.

THIS INVENTION relates to a wallpapering aid and, in particular to a device for hanging wallpaper, that is for applying and adhering wallpaper to a surface to be papered, such as a wall or ceiling of a building.

Conventionally, a strip of wallpaper is hung by first cutting the strip from a roll of wallpaper, pasting the surface of the paper intended to contact the wall or immersing the strip in water if the paper is of the ready pasted kind, folding the strip into a concertina shape, allowing the paste to soak into the paper, if necessary, and then applying the paper to the wall or ceiling by hand whilst supporting the concertina of paper as it is progressively unfolded and applied to the surface being papered. The hanging of wallpaper in this way is thus a two-handed operation and requires considerable manual dexterity and strength and, whilst professional wallpaper hangers can achieve satisfactory results in a reasonable time, unskilled amateurs and those with physical impairments often find wallpapering a daunting, difficult and time-consuming task, if not one which is beyond their capabilities.

It is an object of the present invention to provide a device for hanging wallpaper which is easy to use and makes it possible for the unskilled person to produce reliable results.

Accordingly, the present invention provides a device for hanging wallpaper, comprising a cradle for supporting a length of wallpaper folded in a concertina fashion, an applicator roller mounted for receiving a leading edge of the supported length of wallpaper and a handle by which a user may hold the device in a position of use with the applicator roller against a surface to be wallpapered and move the device along the surface, so that the length of wallpaper is progressively unfolded from the cradle and pressed against the surface by the applicator roller as the device is moved along the surface.

Preferably, the cradle is provided with means for holding the trailing edge of a length of wallpaper supported in the cradle to ensure that the length of paper unfolds evenly along its length.

Advantageously, the handle is adjustably mounted on the cradle to enable the position of the handle relative to the applicator roller to be adjusted for surfaces having different orientations. For example, the handle may be mounted on the cradle for movement along an arcuate track formed on the cradle.

Conveniently, the cradle is constructed as framework comprising a pair of partially spiral arms held in parallel spaced apart relationship by a pair of cross bars, outer ends of the arms being formed into oppositely directed coaxial linear extensions on which the applicator roller is rotatably mounted.

In preferred embodiment, the handle is adjustably mounted for movement along an arcuate slot defined by a pair of arcuate rails mounted on and extending between the cross bars, the end of the handle at the slot having a threaded bore to receive a locking member which can be loosened to allow the handle to be slid along the slot or tightened to lock the handle in the desired position.

In order that the invention may be more readily understood, an embodiment thereof will now be described, by way of example, with reference to the accompanying drawings, in which:

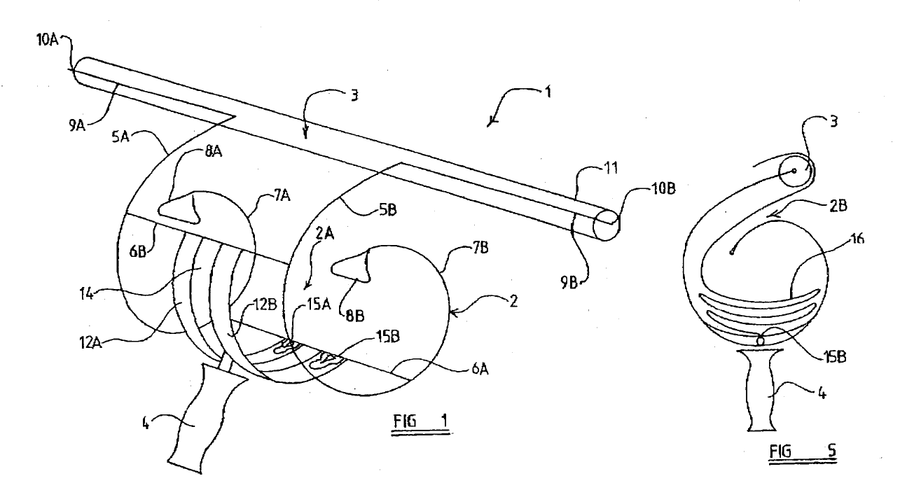

FIG. 1 is a schematic perspective view from above of one embodiment of a wallpaper hanging device according to the invention;

FIG. 2 is plan view of the wallpaper hanging device of FIG. 1;

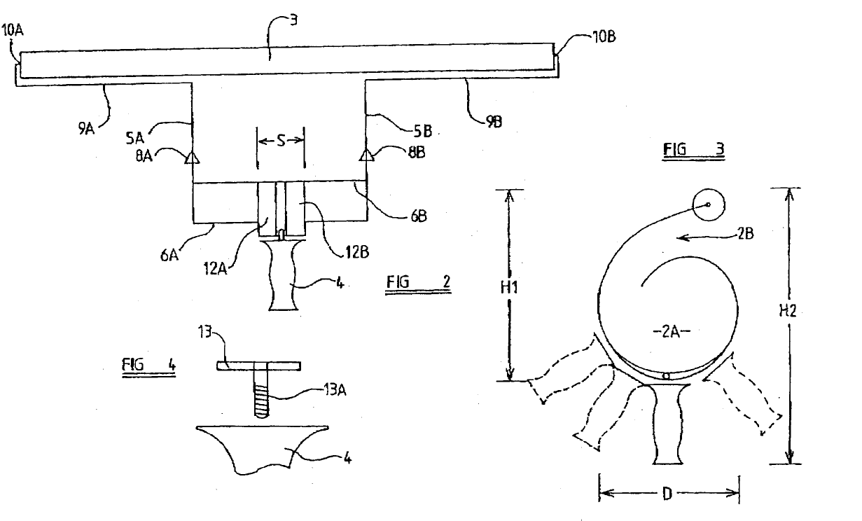

FIG. 3 is a side view of the wallpaper hanging device shown in FIGS. 1 and 2, illustrating the adjustability of a handle of the device;

FIG. 4 is a schematic fragmentary side view of the adjustable handle and its locking member; and

FIG. 5 is a side view of the device of FIGS. 1 to 3, showing the wallpaper hanging device loaded with a folded length of wallpaper.

Referring firstly to FIGS. 1 and 2, a wallpaper hanging device 1 embodying the present invention comprises a cradle 2 for supporting a length of wallpaper folded in concertina fashion, an applicator roller 3 mounted on the cradle 2 for receiving a leading end portion of the length of wallpaper and a handle 4 attached to the cradle 2.

In the illustrated embodiment, the cradle 2 is constructed as a framework comprising a pair of main arms 5A and 5B connected together by two crosspieces 6A and 6B which are of equal length and hold substantially spiral portions 7A and 7B of the arms 5A and 5B in an aligned spaced-apart relationship with the general planes of the spiral portions 7A and 7B parallel. The portions 7A and 7B spiral outwardly from inner end portions of the arms 5A and 5B, which are formed into triangular stops 8A and 8B, to outer end portions of the arms 5A and 5B, which are formed as support arms 9A and 9B extending away from each other substantially at right angles to the general plane of the spiral portions 7A and 7B. The support arm 9A and 9B are doubled back on themselves to form respective mounting spindles 10A and 10B on which the applicator roller 3 is rotatably mounted so as to extend parallel to the support arms 9A and 9B.

In an exemplary embodiment, the main arms 5A and 5B of the cradle 2 are made of 4 mm mild steel and the crosspieces 6A and 6B are made of 3 mm mild steel. The spiral portions 7A and 7B of the arms 5A and 5B are spaced apart about 178 mm, the and the support arms 9A and 9B are about 185 mm long.

The applicator roller 3 comprises an internal aluminium tube (not shown) and an external covering 11. The aluminium tube serves as a bush into which the mounting spindles 10A and 10B of the cradle 2 are inserted to mount the applicator roller 3 rotatably on the cradle 2. The external covering 11 presents a resilient outer surface to avoid damaging the wallpaper and may be constructed from any suitable material or combination of materials, for example a synthetic plastics material or materials. In the exemplary embodiment, the applicator roller 3 has an outer diameter of about 30 mm and a length which is substantially equal to the standard wallpaper width of 520 mm. The internal bush of the applicator roller 3 is constructed from 6 mm aluminium tubing.

Referring particularly to FIGS. 1 and 4, a pair of curved strips 12A and 12B are secured to the crosspieces 6A and 6B in spaced apart relationship, so as to extend parallel to one another substantially in alignment with the shape of a corresponding section of the spiral portions of the arms 5A and 5B. The strips 12A and 12B form a slideway along which the handle 4 may be slid and positioned to steplessly vary the position of the handle 4 relative to the applicator roller 3 over a range of angles to adapt the device for use with differently oriented surfaces to be papered. A threaded shank 13A of a T-shaped locking member 13 is inserted through a slot 14 defined between the strips 12A and 12B and screws into a correspondingly threaded bore in the handle 4 to clamp the strips 12A and 12B between confronting surfaces of the locking member 13 and the handle 4 to lock the handle in position on the slideway. When required, the position of the handle 4 can be adjusted by slackening the locking member 13, moving the handle 4 along the slot 14 to the desired position and tightening the locking member 13 to lock the handle 4 in the selected position along the slideway.

In the exemplary embodiment, the overall width S of the slideway defined by the strips 12A and 12B is about 70 mm and the handle is about 126 mm long. The overall distance between the free end of the handle 4 and the applicator roller 3 is H1 equals about 305 mm when the positioning of the handle results in the smallest distance and H2 equals about 445 mm when the positioning of the handle gives the least distance. With the handle positioned at its furthest from the application roller, the distance D across the spiral portion 6A, 6B substantially at right angles to the line joining the handle and application roller is about 240 mm. The total weight of the unloaded device is about 620 gm.

As also shown in FIG. 1, each of the strips 12A and 12B carries a respective clip 15A or 15B at its radially inner end which is connected to the crosspiece 6A. This clips 15A and 15B serve loosely to hold the trailing end of the 15A anD length of wallpaper to facilitate the dispensing of the wallpaper from the cradle 2 as the device 1 is moved over the surface to be papered.

In use of the device 1 described above, the required length of wallpaper is cut from a roll of wallpaper, pasted and folded in a concertina fashion in the conventional manner. After allowing the length of wallpaper to soak as necessary, the folded length of wallpaper 16 (see FIG. 5) is loaded into the receptacle 2A defined by the cradle 2 and the trailing edge of the wallpaper is inserted into the clips 15A and 15B. The leading edge of the wallpaper is then led out of the cradle 2 through the throat 2B of the cradle and around the applicator roller 3 as shown in FIG. 5, so that the unpasted side of the wallpaper faces the surface of the application roller. The roller is then positioned at the start of the surface to be papered and is set with reference to a datum line, if the length of wallpaper is the first length to be hung, or otherwise with reference to the edge of a previously hung length. The application roller is then brought into contact with the surface to be papered and the device is moved over the surface, maintaining the application roller in contact with the wall and following the datum line or previous wallpaper edge, so that the length of wallpaper is progressively dispensed from the cradle 2 and adhered to the surface by the application roller 3. The trailing edge of the wallpaper is pulled from or can be manually released from the clips 15A and 15B as the device reaches the end of its movement over the surface. The ends of the hung length of wallpaper can then be trimmed as necessary and re-applied to the surface manually to complete the operation.

The described device thus enables a length of wallpaper to be simply and reliably applied to a surface to be wallpapered, even by an inexperienced person using heavy or embossed wallpapers. The application roller applies a uniform pressure to the wallpaper and reduces the incidence of air bubbles compared to the use of a wallpaper brush. Moreover, since the device supports the wallpaper as it is hung, the device can be operated using a single hand. It is envisaged that the device will be of particular value in wallpapering ceilings and other surfaces where it is especially difficult to support the wallpaper as it is being hung. The described device can be made lightweight and should therefore be able to be easily and conveniently used by a broad spectrum of the people who wish to hang wallpaper, either as amateurs or professionally.

1. A device for hanging wallpaper, comprising a cradle for supporting a length of wallpaper folded in a concertina fashion, an applicator roller mounted for receiving a leading edge of the supported length of wallpaper and a handle by which a user may hold the device in a position of use with the applicator roller against a surface to be wallpapered and move the device along the surface, so at the length of wallpaper is progressively unfolded from the cradle and pressed against the surface by the applicator roller as the device is moved along the surface in which device the cradle is provided with means for holding the trailing edge of a length of wallpaper supported in the cradle to ensure that the length of paper unfolds evenly along its length.

2. A device according to claim 1, wherein the handle is adjustably mounted on the cradle to enable the position of the handle relative to the applicator roller to be adjusted for surfaces having different orientations.

3. A device according to claim 2, wherein the handle is mounted on the cradle for movement along an arcuate track formed on the cradle.

4. A device according to any one of claims 1 to 3, wherein the cradle is constructed as framework comprising a pair of partially spiral arms held in parallel spaced apart relationship by a pair of cross bars, outer ends of the arms being formed into oppositely directed coaxial linear extensions on which the applicator roller is rotatably mounted.

5. A device according to claim 4, wherein the handle is adjustably mounted for movement along arcuate slot defined by a pair of arcuate rails mounted on and extending between the cross bars, the end of the handle at the slot having a threaded bore to receive a locking member which can be loosened to allow the handle to be slid along the slot or tightened to lock the handle in the desired position.

6. A device according to claim 5, wherein the holding means for the trailing edge of a length of wallpaper comprises a pair of clips, each of which is carried by a respective one of the arcuate rails.

7. A device for hanging wallpaper substantially as hereinbefore described with reference to the accompanying drawings.
